(19) United States
(12) Patent Application Publication
(10) Pub. No.: US 2026/0358789 A1
(43) Pub. Date: Nov. 12, 2026

(54) MATCH MARKER FOR TIRE ASSEMBLY SYSTEMS

(71) Applicant: INTERNATIONAL WHEEL & TIRE COMPANY, Farmington Hills, MI (US)

(72) Inventors: Harsh Suresh Shah, Royal Oak, MI (US); Todd Allen Campbell, LaSalle, MI (US); Ghanem Jandali, Farmington Hills, MI (US); Nader Younes, Farmington Hills, MI (US); Richard Standon, Farmington Hills, MI (US); Netresh U. Rege, Farmington Hills, MI (US)

(21) Appl. No.: 19/136,040

(22) PCT Filed: Dec. 11, 2023
(86) PCT No.: PCT/US2023/083426

§ 371 Date: Jun. 5, 2025

Related U.S. Application Data
(60) Provisional application No. 63/431,899, filed on Dec. 12, 2022.

(51) Int. Cl. G05B 19/418; B25J 9/16

(52) U.S. Cl. CPC G05B 19/41805; B25J 9/1687; B25J 9/1697; G05B 2219/40033; G05B 2219/40584; G05B 2219/40607

(57) ABSTRACT

A method for tire and wheel assembly for matching markings on the wheel and the tire, may include receiving an image from a vision detector of a wheel assembly, determining whether the image indicates that marks on the tire and wheel of the wheel assembly are aligned, instructing a robot to place the wheel assembly at a match marker station in response to the image indicated that the marks are not aligned.

### CROSS-REFERENCE TO RELATED APPLICATIONS

This application claims the benefit of U.S. provisional application Ser. No. 63/431,899 filed Dec. 12, 2022, the disclosure of which is hereby incorporated in its entirety by reference herein.

### TECHNICAL FIELD

The present disclosure relates to automated system for assembling wheel and tire assemblies, particularly for the automobile industry.

### BACKGROUND

Automated systems may be utilized to assemble wheels, which may be subsequently installed onto automobiles.

### SUMMARY

A method for tire and wheel assembly for matching markings on the wheel and the tire, may include receiving an image from a vision detector of a wheel assembly, determining whether the image indicates that marks on the tire and wheel of the wheel assembly are aligned, instructing a robot to place the wheel assembly at a match marker station in response to the image indicated that the marks are not aligned.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a perspective view of a wheel assembly;

FIG. 2 illustrates a cross-sectional side view of the wheel assembly of FIG. 1.

FIG. 3 illustrates a cross-sectional view of a match marker station of a wheel assembly system;

FIG. 4 illustrates a bottom view of a gripper assembly of the match marker station;

FIG. 5 illustrates a perspective view of a portion of the gripper assembly of the match marker station;

FIG. 6 illustrates an example assembly line for the tire assembly;

FIG. 7 illustrates a partial side view of the gripper assembly in a gripping state;

FIG. 8 illustrates a partial side view of the gripper assembly in a relaxed or non-gripping state; and

FIG. 9 illustrates a perspective view of a platform having a plurality of rings; and

FIG. 10 illustrates a bottom view of another example of the gripper assembly of the match marker station.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

During assembly of a wheel and tire assembly, various marks may be placed on a visible area of a tire and matched up with similar markings on a wheel. This allows the soft spots of a tire to align. Traditionally, vision detectors of a wheel and tire assembly system are used to identify the marks on the tires and the wheel. Rollers or shoes may apply pressure to the tire to break the bead and remove the tire from engaging with the wheel. A gripper assembly may then rotate the wheel relative to the tire to align the marks on the wheel with the marks on the tire. However, these systems may include a vision detector ahead of the gripper assembly and after the gripper assembly.

Disclosed herein is a match marker assembly station configured to align marks on the tire with those on the wheel. The match marker assembly station includes a gripper assembly and a plurality of shoes configured to apply force to the top of the tire and release the tire from the wheel. The gripper assembly may then rotate the wheel to align the marks on the wheel with those on the tire. A vision detector may be included therein. In one example, each the tire and the wheel may include a mark or dot.

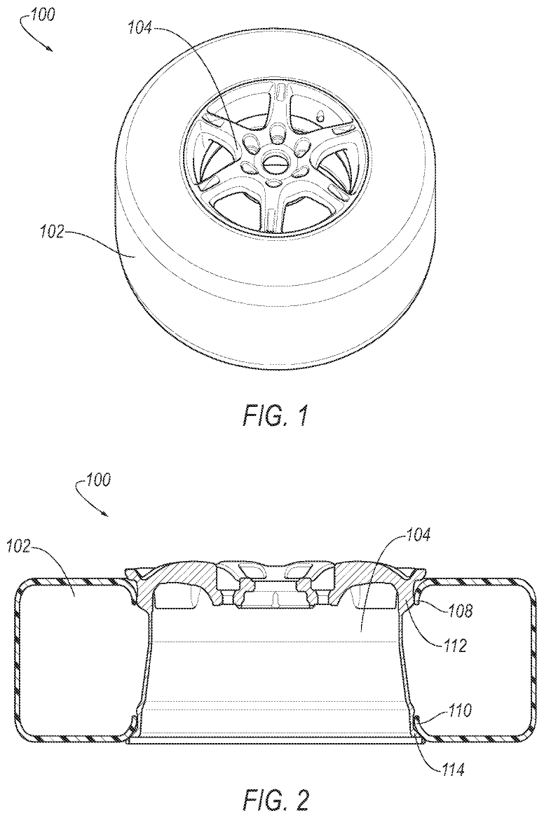

FIG. 1 illustrates a perspective view of a wheel and tire assembly 100. The wheel and tire assembly 100 may include a tire 102 and a wheel 104. During assembly, the tire 102 may be mounted to the wheel 104 by the tire 102 being lowered onto the wheel 104 and manipulated over the rim of the wheel 104 such that the tire is between the flanges or rims 112, 114.

FIG. 2 illustrates a cross-sectional side view of the wheel assembly 100 of FIG. 1. This cross-sectional view illustrates the tire 102 having an upper bead 108 and a lower bead 110. The wheel 104 defines an upper rim 112 and a lower rim 114. The upper bead 108 is configured to be positions slightly below the upper rim 112 (or wheel flange), and the lower bead 110 is configured to be positioned slightly above the lower rim 114, such that the beads 108, 110 rest within the rims 112, 114 of the wheel 104.

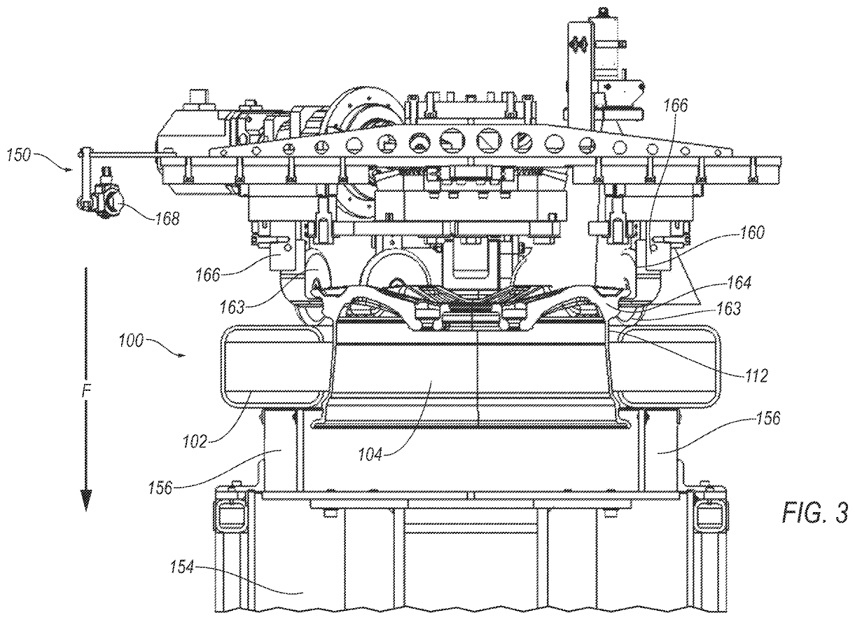

FIG. 3 illustrates a cross-sectional view of a match marker station 152 of a wheel assembly system. The match marker station 152 includes a gripper assembly 150 generally arranged above the wheel and tire assembly 100 when the wheel and tire assembly 100 is at the match marker station 152. The wheel assembly 100 may be arranged on a platform 154 configured to maintain the wheel and tire assembly 100 thereon. The platform 154 may include a ring 156. The ring 156 may be of a size generally similar to that of the wheel 104 of the wheel and tire assembly 100. The ring 156 may be slightly larger than the wheel 104, to support the tire 102 near the lower rim 114. However, in another example, the ring 156 may include a plurality of rings 156, each having a different diameter. In one example, the rings 156 may be spaced along the platform. In another example, the rings 156 may be spaced within a larger radius of another ring. Regardless, the gripper assembly 150 is configured to deliver the wheel and tire assembly 100 to the ring 156 associated with the size of the wheel. In this respect, one match marker station 152 may be configured to handle various wheel sizes.

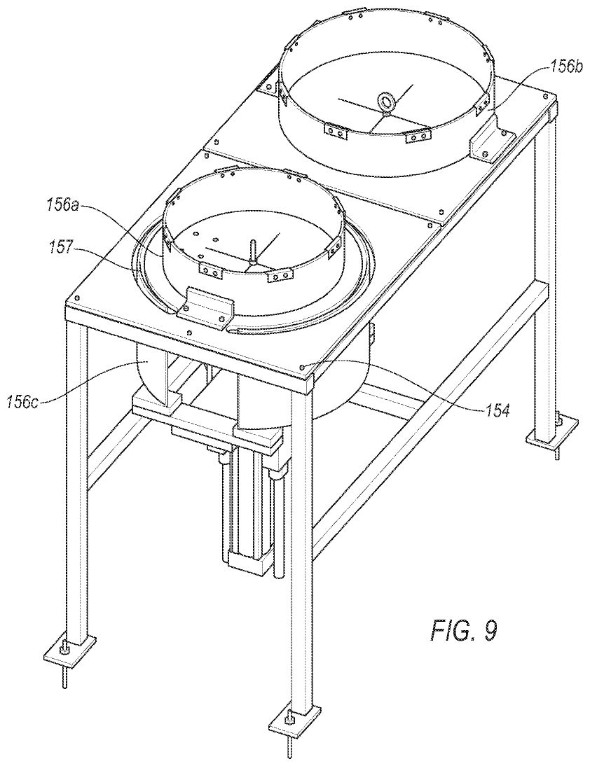

The tire 102 may rest on the ring 156. The ring 156 may be made of a material configured to provide a frictional resistance on the tire 102 in order to maintain the tire 102 on the ring 156 and thus prohibit the tire from rotating, slipping, moving from the ring 156, etc. Further, the ring 156 may protrude upwards from the platform and have a hollow center. The hollow center may have a diameter larger than the diameter of the wheel 104 so as to accommodate the wheel 104 within the hollow center. The ring 156 may be made of metal, plastic, or a combination of both, including other materials such as ceramics, etc. The ring 156 may be a full ring as shown in the figure, or a series of arches, or blocks configured to support the wheel. This is described in more detail with respect to FIG. 9.

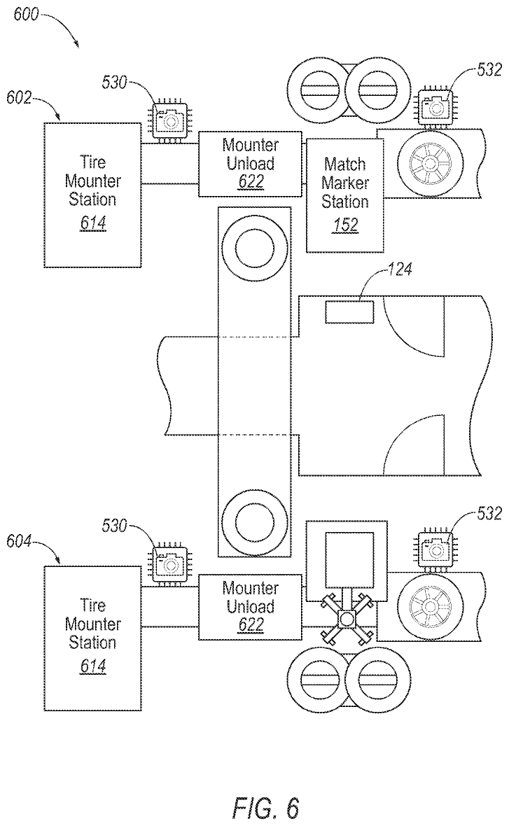

The gripper assembly 150 may be controlled by a controller 124 (illustrated in FIG. 6). The controller 124 may be stand-alone controller specific for the gripper assembly 150, or may be a general controller for the general wheel assembly. The controller 124 may include one or more processors configured to perform instructions, commands and other routines in support of the processes described herein. Such instructions and other data may be maintained in a non-volatile manner using a variety of types of computer-readable storage medium. The computer-readable medium (also referred to as a processor-readable medium or storage) includes any non-transitory medium (e.g., a tangible medium) that participates in providing instructions or other data that may be read by the controller 124 or processor. Computer-executable instructions may be compiled or interpreted from computer programs created using a variety of programming languages and/or technologies, including, without limitation, and either alone or in combination, Java, C, C++, C #, Objective C, Fortran, Pascal, Java Script, Python, Perl, Ladder Logic, and PL/SQL. The system may specifically implement and use a combination of TP programming (Teach Pendant programming) and Karel.

The controller 124 may be configured to control operation of the components of the gripper assembly 150 and the match marker station 152. Further, the controller 124 may be responsible for controlling the robot (not shown) of the assembly system. The controller 124 may be arranged at the match marker station, or may be remote from the station and part of a global control system for the entire assembly system.

The gripper assembly 150 may include a wheel clamp 160 configured to grip the rim 112 of the wheel 104. The gripper assembly 150 may include fingers, ridges, etc., but may also take on other forms in addition to the example shown in the figures. For example, the gripper assembly 150 may include a pivot assembly configured to grip the wheel 104. The gripper assembly 150 may also include at least one shoe configured to abut the tire 102. In the examples in the figures, the shoe may take the form of a curved edge roller 163 where the at least one roller 163 may include at least one wheel or disc configured to rotate about an axis and extend from a roller support 166. The at least one roller 163 may be configured to apply force to the tire 102. By applying force on the tire 102, the roller 163 compresses the tire 102 against the ring 156. Such compression may cause the upper bead 108 to break away from the upper rim 112 of the wheel 104 and the lower bead 110 to break away from the lower rim 114. While shown as a roller 163, the shoe may take on other forms and may have a smooth or less-frictional surface to enable the shoe to move along the tire 102 during use.

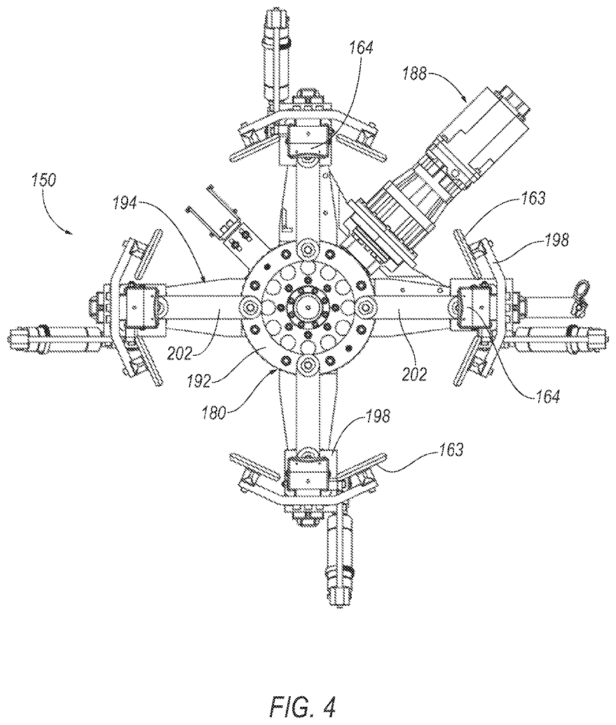

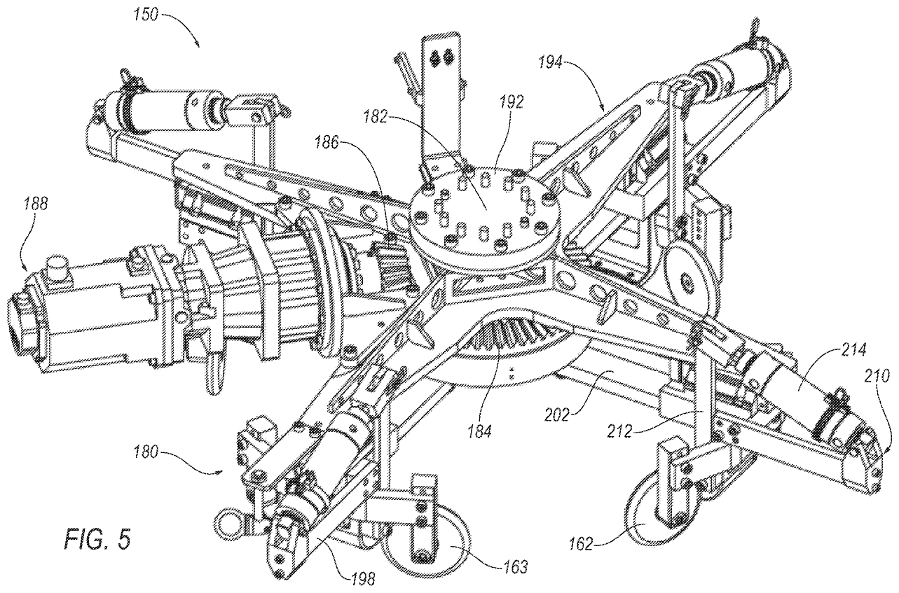

The at least one shoe may include a plurality of rollers 163 include a plurality of pairs of rollers. Each roller 163 may be arranged on the roller support 166 at an attachment point, and in the example shown in the figures (as best shown in FIGS. 4 and 5), each roller support 166 may carry a pair of rollers 163. The rollers 163 may be position radially inward to mimic the curvature of the tire 102. The gripper assembly 150 is configured to rotate, and as the gripper assembly 150 rotates, the rollers 163 are configured to rotate about the attachment point to roll across the tire 102.

The wheel clamp 160 may engage with a gripper bracket 164 extending from the roller support 166. The gripper bracket 164 may extend from the roller support 166 or may form part of the roller support 166. The gripper bracket 164 may include a lip configured to engage an outer edge to form the wheel clamp 160. The gripper bracket 164 and the rollers 163 move together in the vertical direction to apply force F to the wheel and tire assembly 100. During such vertical movement, the wheel 104 may recess into the hollow center of the ring 156.

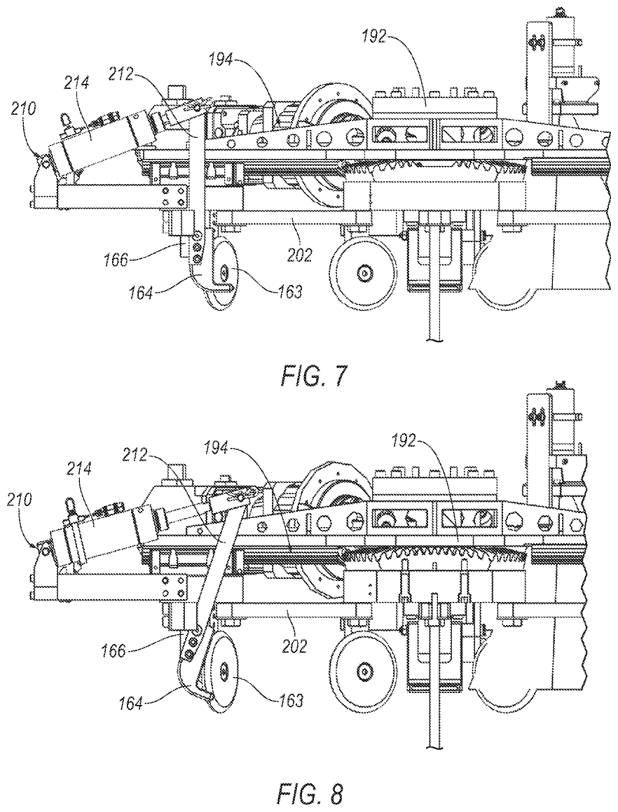

The roller support 166 and/or gripper bracket 164 may also move laterally to engage and grip the wheel 104. This is described in more detail with respect to FIGS. 4 and 5, as well as FIGS. 7 and 8.

As force is applied downward by the gripper assembly 150, and once the beads 108, 110 are broken, the gripper assembly 150 may rotate. Such rotation may cause the roller support 166 and the wheel clamp 160 to rotate, thus causing the wheel 104 to rotate. Additionally or alternative, the beads 108, 110 may break concurrently with the gripper assembly 150 rotating. The rollers 163 may also rotate with the roller support 166. The rollers 163 may concurrently apply downward force onto the tire 102 and roll radially about the top of the tire 102 while the gripper assembly 150 rotates. The ring 156, as explained above, may provide a frictional surface to maintain the tire 102 in a fixed position, thus preventing the tire 102 from rotating. The tire 102 may be compressed between the ring 156 and the rollers 163 to break the beads 108, 110 and maintain the tire 102 fixed relative to the wheel 104. Accordingly, the wheel 104 may be rotated relative to the tire 102, which remains in a fixed position relative to the ring 156.

The force exerted by the gripper assembly 150 may be monitored via a torque sensor or servomotor. Additionally or alternatively, the force may be monitored based on a change in distance of the gripper assembly 150.

During assembly of the wheel and tire assembly 100, various marks may be placed on an outside of a tire 102 and matched up with similar markings on the wheel 104. This allows the soft spots of a tire to align. By rotating the wheel 104, the gripper assembly 150 may align the marks on the tire 102 with those on the wheel 104. This may be confirmed using a vision detector once the wheel and tire assembly 100 is matched. In one example, this audit may be performed using a vision detector 168 arranged on the gripper assembly 150. In another example, and described in more detail below with respect to FIG. 6, additional vision detectors or cameras may be arranged along an assembly line to audit the matching. Additionally or alternatively, the wheel and tire assembly 100 may be pre-matched prior to arriving at the match marker station 152. Again, this is described in more detail with respect to FIG. 6.

Once the vision detector 168 determines that the marks are aligned, the gripper assembly 150 may retract in the opposite direction of the force F. The rollers support 166 may move vertically, decreasing the force applied to the top of the tire 102 by the rollers 163. As this occurs, the bottom bead 110 may move back to its original position, though the top bead 108 may remain compressed. The wheel clamp 160 may disengage from the wheel 104 and the wheel and tire assembly 100 may be moved to the next station, cither by conveyor, robot, or by the gripper assembly 150.

FIG. 4 illustrates a bottom view of a portion of the gripper assembly 150 of the match marker station 152. FIG. 5 illustrates an isometric view of the gripper assembly 150 of the match marker station 152. Referring to FIGS. 4 and 5, the gripper assembly 150 may be mounted to the robot (not shown). The gripper assembly 150 is configured to rotate via the robot. In the example shown in FIG. 4, the gripper assembly 150 includes a base 180 having a center portion 192 and at least one pair of arms 194 extending outwardly from the center portion 192. In the example shown, the base 180 includes four arms 194, equally spaced from one another and forming a ninety degree angle from the adjacent arm 194. While four arms are shown, more or less arms 194 may be appreciated. The arms 194 may form a cross-like shape having four extensions extending from a center portion 192. In the example shown, each arm 194 is of generally equal length, though different lengths may be appreciated. The center portion 192 may include a mounting bracket 182 configured to mount to the robot during use.

A base gear 184 may be arranged at an opposite or underside of the base 180. The base gear 184 may be configured to engage with a drive gear 186 of a drive gear assembly 188 or motor. The drive gear assembly 188 may rotate the drive gear 186. The drive gear 186 may be arranged generally perpendicular to the base gear 184 and upon rotating by the drive dear assembly 188, may in turn engage the gears of the base gear 184 to rotate the base gear 184. The base gear may then rotate the center portion 192, which may move the arms 194 along a track 202 and pull a support backet 198 along with the roller 162, inward to grip the tire 102. FIG. 4 illustrates the gripper assembly 150 in an open state.

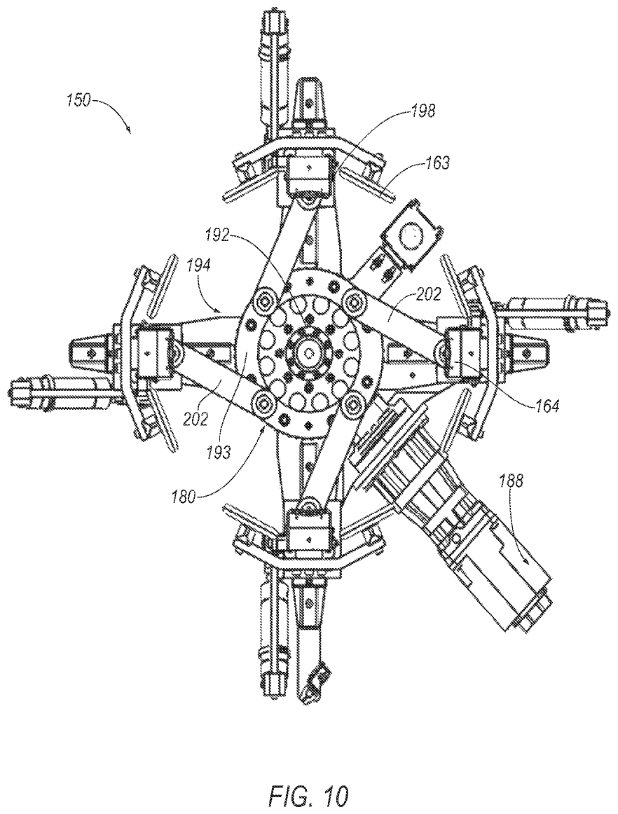

Referring to FIG. 10, which is a top view of a portion of the gripper assembly 150 of the match marker station 152, the arms 194 may also attach to an outer diameter 193 of the center portion 192. In this example of the arms 194 being arranged at the diameter 193 of the center portion 192, the rotation of the center portion 192 may pull the arms 194 around the center portion 192 and thus draw the support bracket 198 and roller 163 inward to grip the tire.

The controller 124 may receive feedback from the system and may instruct the gripper assembly 150 in view of the data provided by the various elements of the gripper assembly 150. For example, the controller 124 may instruct the drive gear assembly 188 to rotate to grip the tire 102.

Each arm 194 of the base 180 may maintain the support bracket 198. The support bracket 198 may carry the roller support 166 and at least one roller 163. In the example shown in the figures, a pair of rollers 163 is arranged on each support bracket 198. The two rollers 163 making up the pair of rollers may be angled relative to one another in a obtuse angle. This arrangement may be configured to accommodate the radial shape of the tire 102, allowing the rollers 163 to easily glide along the tire 102 during operation. The rollers 163 may be carried by the roller support 166 extending from the support bracket 198. The roller support 166 may be fixed to the support bracket 198, or in the alternative, may be one made of the same piece as the support bracket.

As explained above, the support bracket 198 may also maintain the gripper bracket 164. The gripper bracket 164 may be part of the roller support 166 and as explained, may form a lip configured to engage the upper rim 112 of the wheel 104. The gripper bracket 164 may be arranged adjacent the rollers 163 such that the gripper bracket 164 is arranged inside the rollers 163.

As explained, the arms 194 may include the support bracket 198 at the distal end thereof. Each arm 194 may include a track 202 extending along the length of the arm 194 at the underside of the arm 194. The track 202 may engage with the support bracket 198 and the support bracket 198 may be movable along the track 202 or rotatable with the center portion 192. Such movements may cause an adjustment in the diameter between the gripper bracket 164 and the opposite one of the gripper bracket 164. This may allow for an accommodation of various sizes (or diameters) or wheel assemblies 100. The support bracket 198 may move inwardly to accommodate the dimeter of the wheel 104. In the example where a pivot assembly is used in place of the gripper assembly 150, such tracks 202 may not be necessary.

In the example shown, each support bracket 198 may be moved laterally along the track 202 via the drive gear assembly 188. A hinge assembly 210 may selectively clamp and unclamp the wheels, as shown in FIGS. 7 and 8. The hinge assembly 210 may include a lever arm 212 and an actuator 214. The actuator may be a cylinder 214 may be a pneumatic cylinder configured to control a piston rod to selective actuate the lever arm 212. The cylinder 214 may also be driven electrically.

FIG. 7 illustrates a partial side view of the gripper assembly 150 in a gripping state. FIG. 8 illustrates a partial side view of the gripper assembly 150 in a relaxed or non-gripping state. In FIG. 7, the lever arm 212 may be generally vertical. This is caused by the cylinder 214 may be in a collapsed state and holding he lever arm 212 vertical. In this state, the gripper bracket 164 may engage with the wheel.

FIG. 8 illustrates the cylinder 214 being in an extended state, thus pushing a first end of the lever arm 212 towards the center portion 192. The opposite second end of the lever arm 212 may consequently pull the gripper bracket 164 away from the center portion 192, thus disengaging the wheel 104. Though FIGS. 7 and 8 are discussed by way of example of illustrating a gripper state and a relaxed state. While the bracket 198 may move laterally to accommodate the tire's diameter, the hinge assembly 210 may be configured to clamp the tire. The cylinder 214 may be in communication with the controller 124, which may instruct the cylinder 214 to move between the gripping state and the relaxed state.

Additionally or alternatively, a force sensor may be present at or on the support bracket 198 and the controller 124 may instruct the driver to move the support bracket 198 inward along the track 202 until a predefined force is recognized at the support bracket 198. That is, the support bracket 198 may abut the wheel 104 and be controlled via one or both of a known diameter of the wheel or a desired force.

Referring back, FIG. 6 illustrates an example assembly line 600 for the wheel and tire assembly, including, in this example, a first line 602 and a second line 604. More or less lines may be contemplated. Each line may include the match marker station 152, as well as other stations, including a wheel match vision station, tire mounter station 622, inflator, wheel and tire loaders, etc., to name a few. A cross-conveyor 620 may allow a wheel and tire assembly 100 to be moved between the two lines 602, 604 via the robot. The robot may move the wheel and tire assembly between lines 602, 604, as well as orient the tire prior to the tire mounter station 614 or the match marker station 152. At the wheel match vision station 610, marks on the wheel 104 may be identified prior to the wheel 104 maying mounted on the tire 102 at the tire mounter station 614. A first camera 530 may then verify if the marks on the tire 102 align with those of the wheel 104. In this example, the wheel and tire assembly 100 is pre-matched prior to the tire mounter station 614 and the match marker station 152. If the wheel and tire assembly 100 is pre-matched, then it is possible that the wheel and tire assembly 100 may not require the match marker station 152. In this case, the robot may move the wheel and tire assembly 100 directly to an inflator (not shown).

If the wheel and tire assembly 100 is not pre-matched, or not pre-matched correctly, then the robot may move the wheel and tire assembly 100 to match mark the wheel and tire assembly 100. Once match marker station 152 performs its function, the wheel assembly 100 may move on the inflator, or other station, via the robot. A camera, such as second camera 532, may be arranged at the match marker to verify that the wheel and tire assembly 100 is matched. The camera 532 may also be arranged on the robot.

Due to the setup of the assembly line, the robot may selectively move the wheel and tire assembly 100 to the appropriate station, allowing for a flexible method and process. This may be done via the cross-conveyor 620. Such a pick and place method may allow the wheel and tire assembly 100 to be placed at one station on the first line 602 from the second line 604. This may be advantageous if a portion of one of the lines or a certain station experiences delays to setbacks, as the process may continue. Such a modular line is facilitated by the placement of the robots, the cross over conveyors, and a modular line. In examples where multiple lines are included, if a station at one line goes down, the part may be moved to another line via the robot and/or cross conveyor, without the entire line needed to be shut down or the parts from line to be moved entirely to another. Further, the lines may continue to operate, and the need to shut down and/or evacuate the entire area for repair is negated.

The assembly line 600 may include at least one camera at or near the beginning of the line to verify and identify the marks on each of the tire 102 and wheel 104, as well as a second camera down the line to audit the alignment of the marks to verify that the tire 102 and the wheel 104 have been appropriately matched. In another example, a single camera may be arranged on the robot itself, which may decrease cycle time. In the example of a dual camera assembly of FIG. 5, the first camera 530 may be at the mounter station 614, and the second camera 532 may be at the inflator (not shown). In another example, the second camera may be on the robot. In this case, the second camera may audit and validate that the tire 102 and wheel 104 are matched. Accordingly, there are numerous options for the number and placement of the cameras/vision detectors along the assembly.

FIG. 9 illustrates a perspective view of a platform 154 having a plurality of rings 156. In this example, as described above, the platform 154 is configured to maintain the wheel and tire assembly 100 thereon. The platform 154 may include at least one ring 156. The ring 156 may be of a size generally similar to that of the wheel of the wheel and tire assembly 100. The ring 156 may be slightly larger than the wheel 104, to support the wheel 104 near the lower rim 114. However, in another example, the ring 156 may include a plurality of rings 156, each having a different diameter. In one example, the rings 156 may be spaced along the platform, as shown in FIG. 9 and include a first ring 156a and a second ring 156b. Each ring may be adjacent the other and each may have a differing diameter to accommodate a specific size of the wheel and tire assembly 100. The gripper assembly 150 is configured to deliver the wheel and tire assembly 100 to the ring 156 associated with the size of the wheel. In this respect, one match marker station 152 may be configured to handle various wheel sizes.

During operation, the tire 102 may rest on the ring 156. As explained, the ring 156 may be made of a material configured to provide a frictional resistance on the tire 102 in order to maintain the tire 102 on the ring 156 and thus prohibit the tire from rotating, slipping, moving from the ring 156, etc. Further, the ring 156 may protrude upwards from the platform and have a hollow center. The hollow center may have a diameter larger than the diameter of the wheel 104 so as to accommodate the wheel 104 within the hollow center. The ring 156 may be made of metal, plastic, or a combination of both, including other materials such as ceramics, etc. The ring 256 may be a full ring as shown in the figure, or a series of arches, or blocks configured to support the wheel. This is described in more detail with respect to FIG. 9.

Additionally or alternatively, a third ring 156c may be maintained below the platform 154 and be selectively received via at least one slot 157 defined by the platform. This third ring 156c may be of a greater or lesser diameter than the first ring 156a, and may be configured to provide additional size allocations for the system. The third ring 156c may be controlled via a pneumatic or electric cylinder arranged thereover and selective extended through the slots 157 in response to instructions from the controller 124. In this example, the third ring 156c is illustrates as a pair of arches.

The embodiments of the present disclosure generally provide for a plurality of circuits, electrical devices, and at least one controller. All references to the circuits, the at least one controller, and other electrical devices and the functionality provided by each, are not intended to be limited to encompassing only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

It is recognized that any controller as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any controller as disclosed utilizes any one or more microprocessors to execute a computer-program that is embodied in a non-transitory computer readable medium that is programmed to perform any number of the functions as disclosed. Further, any controller as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware based inputs and outputs for receiving and transmitting data, respectively from and to other hardware based devices as discussed herein.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for a tire and wheel assembly for matching markings on the wheel and the tire, comprising:
receiving an image from a vision detector of a wheel assembly;
determining whether the image indicates that marks on the tire and wheel of the wheel assembly are aligned;
instructing a robot to clamp and place the wheel assembly at a platform in response to the image indicated that the marks are not aligned; and
instructing the robot to rotate a wheel of the wheel assembly relative to the tire to align the marks.

2. The method of claim 1, further comprising:
instructing at least one roller to apply force to the tire of the wheel assembly so as to pinch the tire between the roller and a ring arranged on an opposite side of the wheel assembly than the roller to break a bead connection between the wheel and the tire allowing the wheel to rotate with respect to the tire in order to align the marks on the wheel with those of the tire.

3. The method of claim 2, wherein the at least one roller breaks a first bead by applying force to the tire and wherein the ring breaks a second opposite bead in response to the tire being placed on the ring.

4. The method of claim 2, further comprising instructing the at least one roller to retract from applying force to the tire allowing the bead of the tire to reengage with the wheel.

5. The method of claim 4, further comprising receiving another image from the vision detector of the wheel assembly to verify that the marks on the tire and the wheel of the wheel assembly are aligned.

6. The method claim of claim 5, wherein the vision detector is carried by the robot.

7. The method of claim 5, further comprising instructing the robot to place the wheel assembly at an outbound station.

8. The method of claim 7, wherein robot and platform are part of a match marker station is on a first assembly line and the outbound station is on a separate second assembly line.

9. The method of claim 8, wherein the outbound station is one of a station or conveyor on an assembly line separate and distinct from the match marker.

10. A match marker assembly for a wheel assembly system, comprising:
a gripper assembly configured to grip a wheel of a wheel assembly at a first side of the wheel assembly;
at least one ring arranged spaced and opposite the gripper assembly and configured to abut a tire of the wheel assembly;
wherein the gripper assembly includes at least one wheel clamp configured to grip the wheel and at least one shoe configured to abut and apply force to the tire at the first side of the wheel assembly,
a controller programmed to instruct the gripper assembly to apply force on the wheel assembly forcing the tire to press against the ring causing a bead connection between the wheel and the tire to break allowing the wheel to rotate with respect to the tire in order to align a marking on the wheel with that of the tire.

11. The match marker assembly of claim 10, wherein the at least one shoe incudes a plurality of rollers, each configured to roll along the tire at an opposite side of the one abutting the ring.

12. The match marker assembly of claim 11, wherein gripper assembly includes a base configured to carry the shoe.

13. The match marker assembly of claim 12, wherein the base includes at least one arm extending outwardly from a center portion, the at least one arm configured to carry the at least one shoe on a support bracket at a distal end of the respective arm.

14. The match marker assembly of claim 13, wherein the gripper assembly includes at least one gripper bracket arranged on the support bracket adjacent to the associated shoe of the respective arm, wherein the at least one bracket is configured to engage the wheel clamp and create an opposing force with the at least one bracket arranged on the opposite arm.

15. The match marker assembly of claim 14, wherein the gripper bracket forms a bracket lip configured to engage with a rim of the wheel once the bead connection between the wheel and the tire breaks.

16. The match marker assembly of claim 10, further comprising a hinge assembly fixed at least in part to the wheel clamp, wherein the hinge assembly is configured to move the wheel clamp between a gripping state where the wheel clamp engages the wheel and a relaxed state where the wheel clamp does not engage the wheel.

17. The match marker assembly of claim 16, wherein the hinge assembly includes an actuator coupled to a lever arm, wherein the lever arm is configured to move the wheel clamp between the gripping state and relaxed state according to the actuator cylinder.

18. The match marker assembly of claim 10, further comprising a robot configured to rotate the gripper assembly.

19. The match marker assembly of claim 10, further comprising at least one platform configured to maintain the at least one ring in a fixed position, wherein the platform is configured to frictionally engage the tire on a second side of the wheel assembly opposite the first side of the wheel assembly.

20. The match marker assembly of claim 19, wherein the at least one ring includes a plurality of rings, each having different diameters to accommodate different tire sizes.
